(19) United States
(12) Patent Application Publication
(10) Pub. No.: US 2013/0206989 A1
(43) Pub. Date: Aug. 15, 2013

(54) Radiation Sensor

(71) Applicant: Agency for Science, Technology and Research, (US)

(72) Inventors: Huchuan ZHOU, Singapore (SG); Piotr KROPELNICKI, Singapore (SG); Julius Ming Lin TSAI, Singapore (SG)

(73) Assignee: Agency for Science, Technology and Research, Singapore (SG)

(21) Appl. No.: 13/756,973

(22) Filed: Feb. 1, 2013

(30) Foreign Application Priority Data
Feb. 1, 2012 (SG) SG201200738-1

(51) Int. Cl. G01J 5/02

(52) U.S. Cl. CPC G01J 5/02
USPC 250/338.1

(57) ABSTRACT

A radiation sensor is provided. The radiation sensor includes a substrate; a diaphragm positioned over the substrate; an absorbing layer which is configured to absorb infrared radiation; a supporting element arranged between the absorbing layer and the diaphragm such that a spacing gap is formed between the absorbing layer and the diaphragm; wherein the size of the spacing gap is in a range of about 3.6 micrometer to about 100 micrometer.

### CROSS-REFERENCE TO RELATED APPLICATION

This application claims the benefit of priority of Singapore Patent Application No. 201200738-1, filed 1 Feb. 2012, the contents of which are hereby incorporated by reference in its entirety for all purposes.

### TECHNICAL FIELD

Various embodiments relate generally to a radiation sensor.

### BACKGROUND

Detection of substances (such as fluid or gas molecules) based on their unique infrared (IR) absorption characteristics is a widely used method. Its application covers the fields from home (e.g., air condition monitoring or fire alarms) to industry (e.g., air pollution monitoring or logging-while-drilling (LWD) tool). It also works for some medical applications. For example, the capnography, which means monitoring CO2 concentration of respiratory gas, provides significant information about patient's conditions. Therefore, developing an IR radiation detector with high performance is crucial for those applications.

Thermopiles are electronic devices that convert thermal energy into electrical energy. Thermopiles are customarily utilized for IR sensor because of their characteristics of detecting temperature difference but not the absolute temperature, which leads to a significant stability to temperature varying.

A conventional thermopile based IR radiation sensor 100 has a suspended membrane 101 with an absorber layer 102 and thermoelectric materials 104 integrated together, as shown in FIG. 1. The membrane 101 is suspended above a cavity 105. The absorber layer 102 will be heated up by IR radiation and the heat will be converted to the thermoelectric part 104. The near-end, relative to the absorber, of the thermopile is called “hot-junction” 106, which is continuously heated by the absorber layer 102. While the substrate converts heat of the far-end to the ambience, this part is “cold-junction” 108, as shown in FIG. 1. Therefore, there is a temperature difference between the cold junction 108 and the hot junction 106. According to Seebeck effect, there will be a difference of voltage between the cold junction 108 and the hot junction 106. It is clear that the design of a highly effective absorber is the first step of building a great IR sensor.

The conventional thermopile based IR sensor 100 usually enhances the performance of the absorber by using effective material which can provide an absorption rate up to over 90%. However, there is still a significant limitation of absorption area. As shown in FIG. 1, the absorption area is limited to the central part, which means the limitation of energy absorbed by the detector, so as to the response to the same radiation intensity.

A 3-D absorber has been utilized for micro-bolometer design. However, the process and design are both not suitable for thermopile. The relatively small size of micro-bolometer and the small gap between the absorber and the thermoelectric layer both limit the performance of thermopile because of air convection.

### SUMMARY

According to one embodiment, a radiation sensor is provided. The radiation sensor includes a substrate; a diaphragm positioned over the substrate; an absorbing layer which is configured to absorb infrared radiation; a supporting element arranged between the absorbing layer and the diaphragm such that a spacing gap is formed between the absorbing layer and the diaphragm; wherein the size of the spacing gap is in a range of about 3.6 micrometer to about 100 micrometer.

According to one embodiment, a radiation sensor is provided. The radiation sensor includes a substrate; a diaphragm positioned over the substrate; an absorbing layer which is configured to absorb infrared radiation; a supporting element arranged between the absorbing layer and the diaphragm such that the absorbing layer has a spaced apart relationship with respect to the diaphragm; a first cavity formed between the absorbing layer and the substrate, the first cavity being vacuum.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a conventional thermopile based infrared radiation sensor.

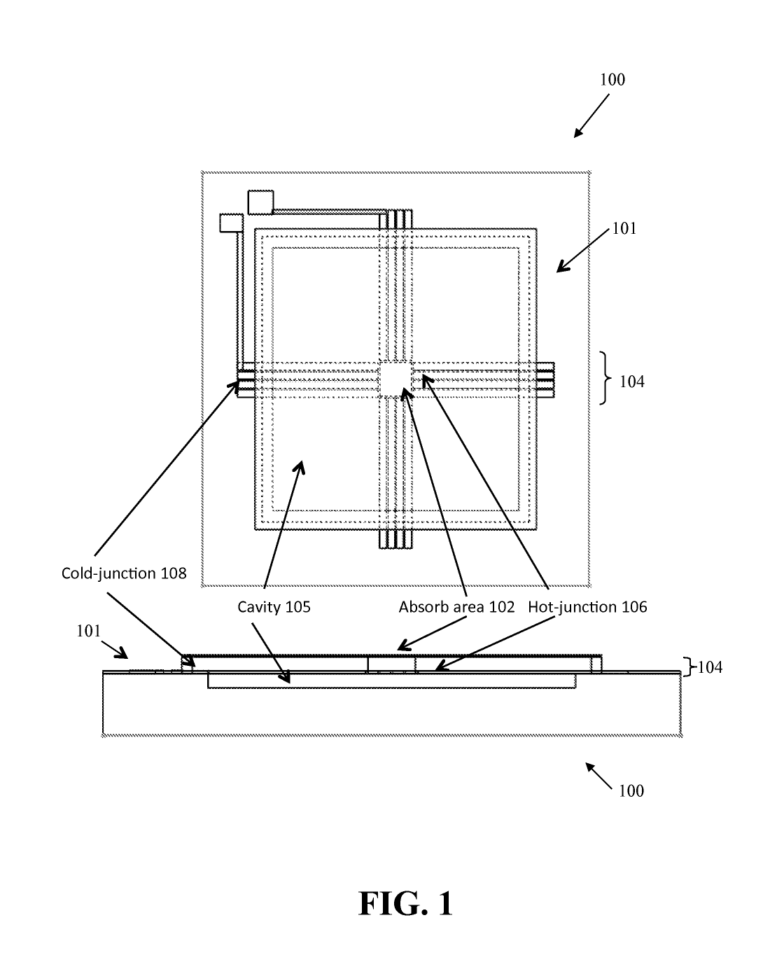

FIG. 2 shows a schematic diagram of a radiation sensor according to one embodiment.

FIG. 3 shows a schematic diagram of a radiation sensor according to one embodiment.

FIG. 4a shows a three-dimensional view of a radiation sensor according to one embodiment.

FIGS. 4b and 4c show cross-sectional views of a radiation sensor according to one embodiment.

FIG. 5 shows a schematic diagram of a radiation sensor according to one embodiment.

FIG. 6 shows an exemplary model of the design of a sensor that includes only 3-D absorber according to one embodiment.

FIG. 7a shows a graph of simulated results of sensitivity (Rs) of three designs of a radiation sensor according to one embodiment.

FIG. 7b shows a graph of simulated results of detectivity (D*) of three designs of a radiation sensor according to one embodiment.

FIG. 8a shows a graph of sensitivity (Rs) and detectivity (D*) plotted against a radius of a supporting element of a radiation sensor according to one embodiment.

FIG. 8b shows a graph of a temperature difference between a hot-junction and a cold-junction plotted against a radius of a supporting element of a radiation sensor according to one embodiment.

FIG. 9a shows a graph of sensitivity (Rs) and detectivity (D*) plotted against a spacing gap in a radiation sensor according to one embodiment.

FIG. 9b shows a graph of a temperature difference between a hot-junction and a cold-junction plotted against a spacing gap in a radiation sensor according to one embodiment.

### DETAILED DESCRIPTION

Embodiments of a radiation sensor will be described in detail below with reference to the accompanying figures. It will be appreciated that the embodiments described below can be modified in various aspects without changing the essence of the invention.

In various embodiments, a 3-D thermoelectric based radiation sensing structure with a large cap layer comprising absorber materials may be described. Microfabricated radiation based thermal sensors which include thermoelectric patterns, a metal stud and a radiation absorber layer on a cap layer may be described.

In context of various embodiments, the term “diaphragm” may be referred to as “membrane”. The term “responsivity” and “sensitivity” can be used interchangeably.

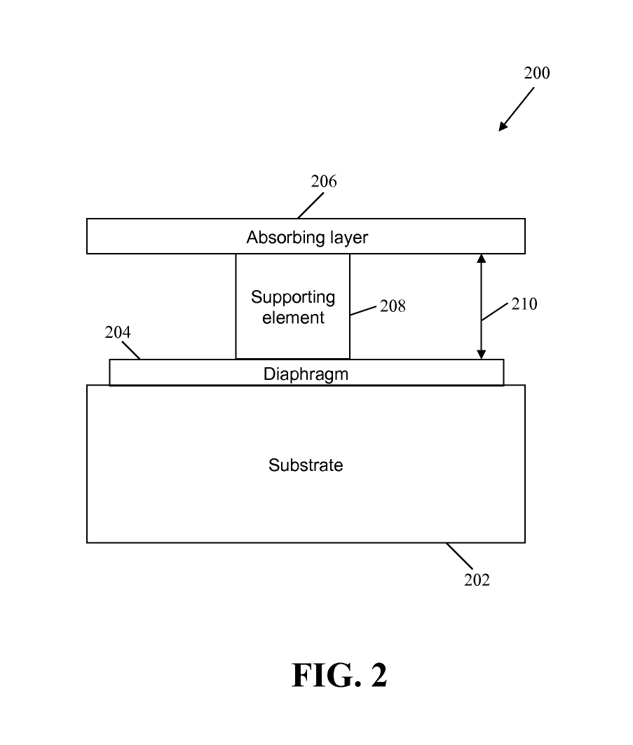

FIG. 2 shows a schematic diagram of a radiation sensor 200 according to one embodiment. The radiation sensor 200 includes a substrate 202 and a diaphragm 204 positioned over the substrate 202. The radiation sensor 200 includes an absorbing layer 206 which is configured to absorb infrared radiation. The radiation sensor 200 also includes a supporting element 208 arranged between the absorbing layer 206 and the diaphragm 204 such that a spacing gap 210 is formed between the absorbing layer 206 and the diaphragm 204. In one embodiment, the size of the spacing gap 210 is in a range of about 3.6 micrometer to about 100 micrometer.

In one embodiment, the diaphragm 204 includes a thermopile structure. The thermopile structure has a hot junction and a cold junction. The supporting element 208 may be in contact with the hot junction of the thermopile structure. The size of the spacing gap 210 may be in a range of about 5 micrometer to about 100 micrometer.

In one embodiment, the size of the spacing gap 210 may be in a range of about 3.6 micrometer to about 50 micrometer, in a range of about 50 micrometer to about 100 micrometer, in a range of about 3.6 micrometer to about 25 micrometer, in a range of about 25 micrometer to about 50 micrometer, in a range of about 50 micrometer to about 75 micrometer, in a range of about 75 micrometer to about 100 micrometer, in a range of about 3.6 micrometer to about 10 micrometer, in a range of about 10 micrometer to about 20 micrometer, in a range of about 20 micrometer to about 30 micrometer, in a range of about 30 micrometer to about 40 micrometer, in a range of about 40 micrometer to about 50 micrometer, in a range of about 50 micrometer to about 60 micrometer, in a range of about 60 micrometer to about 70 micrometer, in a range of about 70 micrometer to about 80 micrometer, in a range of about 80 micrometer to about 90 micrometer, or in a range of about 90 micrometer to about 100 micrometer.

In one embodiment, the diaphragm 204 has a thermal connection to the absorbing layer 206 through the supporting element 208. The supporting element 208 may be made of conductive material. The supporting element 208 may be solid or not solid.

In one embodiment, the radiation sensor 200 includes a first cavity. The first cavity may be formed between the absorbing layer 206 and the substrate 202. The first cavity may encapsulate the thermopile structure and the supporting element 208. The first cavity may be vacuum.

In one embodiment, the radiation sensor 200 further includes a second cavity formed in the substrate 202. The diaphragm 204 may be suspended across the second cavity. The second cavity may be vacuum.

In one embodiment, the absorbing layer 206 covers the diaphragm 204 in an umbrella type configuration. The term “umbrella type configuration” may mean that the absorbing layer 206 has a umbrella shape which extends over the diaphragm 204 and covers the diaphragm 204. It may also mean that the absorbing layer 206 totally envelops the diaphragm 204 in a defined space/cavity.

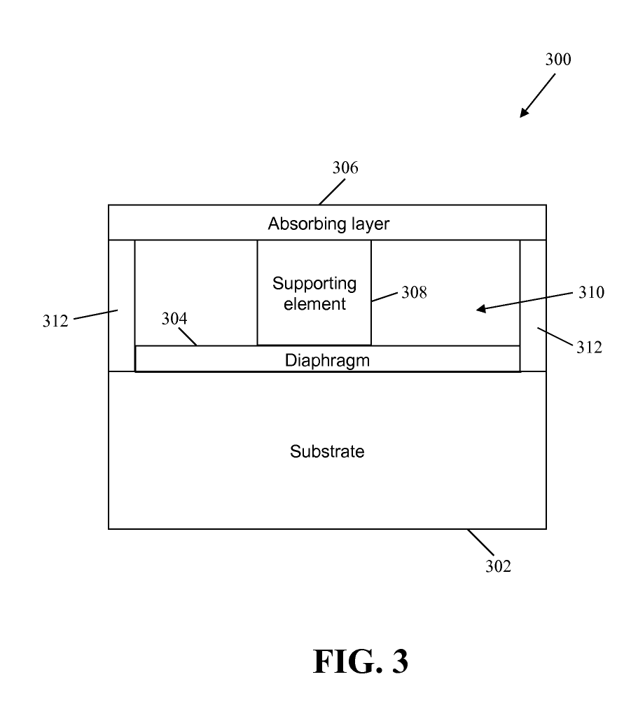

FIG. 3 shows a schematic diagram of a radiation sensor 300 according to one embodiment. The radiation sensor 300 includes a substrate 302 and a diaphragm 304 positioned over the substrate 302. The radiation sensor 300 includes an absorbing layer 306 which is configured to absorb infrared radiation. The radiation sensor 300 also includes a supporting element 308 arranged between the absorbing layer 306 and the diaphragm 304 such that the absorbing layer 306 has a spaced apart relationship with respect to the diaphragm 304. The radiation sensor 300 includes a first cavity 310 formed between the absorbing layer 306 and the substrate 302. The first cavity 310 may be vacuum. The cavity 310 may be formed with sealing material 312 disposed between the absorbing layer 306 and the substrate 302.

In one embodiment, the radiation sensor 300 further includes a second cavity formed in the substrate 302. The diaphragm 304 may be suspended across the second cavity. The second cavity may be vacuum.

In one embodiment, the diaphragm 304 includes a thermopile structure. The thermopile structure has a hot junction and a cold junction. The supporting element 308 may be in contact with the hot junction of the thermopile structure.

In one embodiment, the diaphragm 304 has a thermal connection to the absorbing layer 306 through the supporting element 308. The supporting element 308 may be made of conductive material. The supporting element 308 may be solid or not solid.

In one embodiment, the absorbing layer 306 covers the diaphragm 304 in an umbrella type configuration. The term “umbrella type configuration” may mean that the absorbing layer 306 has a umbrella shape which extends over the diaphragm 304 and covers the diaphragm 304. It may also mean that the absorbing layer 306 totally envelops the diaphragm 304 in a defined space/cavity.

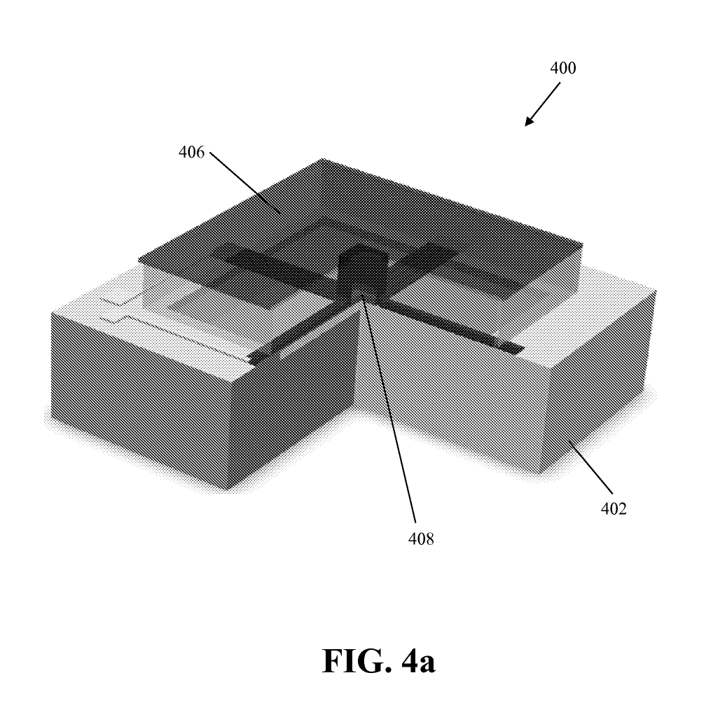

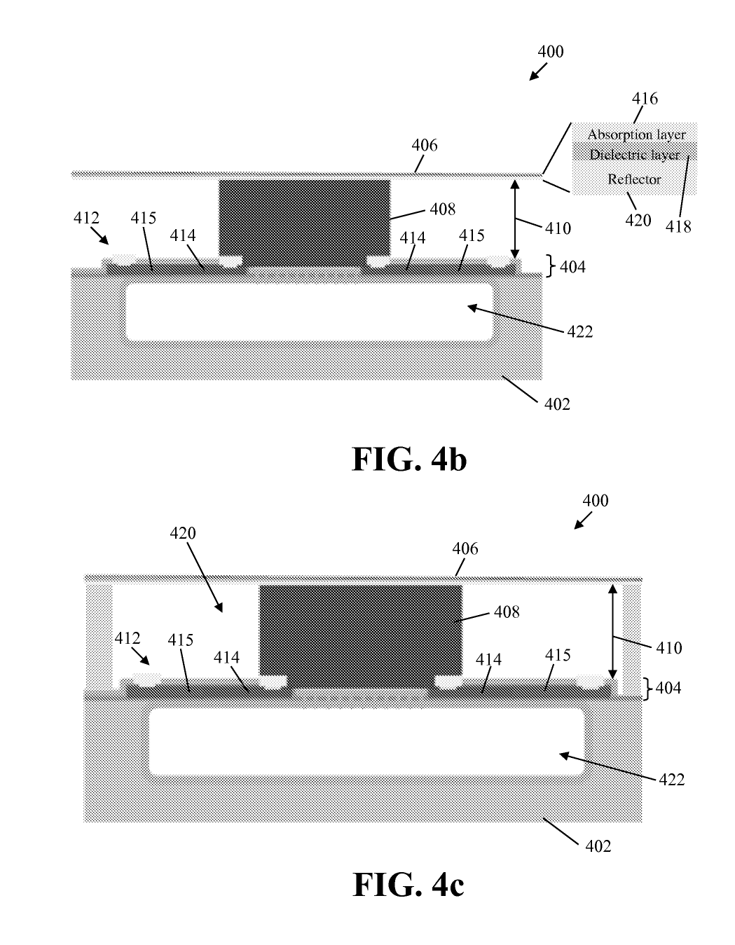

FIG. 4a shows a three-dimensional view of a radiation sensor 400. FIGS. 4b and 4c show cross-sectional views of the radiation sensor 400. The radiation sensor 400 has a substrate 402 and a diaphragm 404 arranged above the substrate 402. The radiation sensor 400 has an absorbing layer 406 and a supporting element 408 arranged between the diaphragm 404 and the absorbing layer 406.

The supporting element 408 is arranged between the diaphragm 404 and the absorbing layer 406 such that the absorbing layer 406 has a spaced apart relationship with respect to the diaphragm 404. There is a spacing gap 410 between the diaphragm 404 and the absorbing layer 406. In one embodiment, the spacing gap 410 is in a range of about 3.6 micrometer to about 100 micrometer. In another embodiment, the spacing gap 410 is in a range of about 5 micrometer to about 100 micrometer. The spacing gap 410 may be independent of a wavelength of e.g. light to which the radiation sensor 400 is to be exposed. The spacing gap 410 may be dependent on thermal conductance and fabrication process. A larger spacing gap 410 is desirable to minimize possible air convection effects between the diaphragm 404 and the absorbing layer 406.

In one embodiment, the diaphragm 404 includes a thermopile structure 412. The thermopile structure 412 may have thermoelectric patterns, e.g. circuitry patterns forming the thermopile. The thermopile structure 412 may have a hot junction 414 and a cold junction 415. The supporting element 408 may be in contact with the hot junction 414 of the thermopile structure 412. Further, the diaphragm 404 may include a thermal connection to the absorbing layer 406 through the supporting element 408.

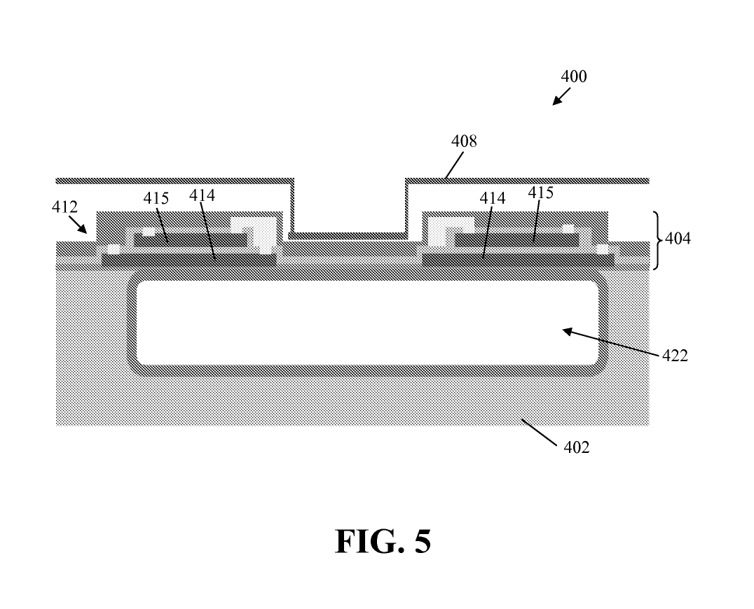

In one embodiment, the supporting element 408 is made of conductive material. The conductive material may be thermally conductive, electrically conductive or both thermally and electrically conductive. The conductive material may include but is not limited to metal. The supporting element 408 may be solid. For example, as shown in FIGS. 4b and 4c, the supporting element 408 is a filled stub (e.g. a metal stud). Alternatively, the supporting element 408 may not be solid. For example, as shown in FIG. 5, the supporting element 408 has a supportive tube like structure. The supporting element 408 can transfer absorbed heat from the absorbing layer 406 to the thermopile structure 412 of the diaphragm 404 (e.g. hot junction 414 of the thermopile structure 412). The supporting element 408 may be formed underneath the absorbing layer 406 so that the whole surface of the absorbing layer 406 can be used to absorb radiation.

In one embodiment, the absorbing layer 406 may include a reflector layer 416, a dielectric layer 418 disposed above the reflector layer 416, and an absorption layer 420 disposed above the dielectric layer 418. The absorbing layer 406 is configured to absorb infrared radiation. The absorbing layer 406 may cover the diaphragm 404 in an umbrella type configuration as shown in FIG. 4c. Thus, an enlarged radiation absorption area can be provided.

In one embodiment, a first cavity 422 is formed between the absorbing layer 406 and the substrate 402. The first cavity 422 encapsulates the diaphragm 404 and the supporting element 408. The first cavity 422 may be vacuum.

The radiation sensor 400 may further include a second cavity 424 formed in the substrate 402. The diaphragm 404 may be suspended across the second cavity 424. The second cavity 424 may be vacuum.

The first cavity 422 and the second cavity 424 can enhance the performance (sensitivity and detectivity) of the radiation sensor 400 by reducing heat loss. The first cavity 422 and the second cavity 424 can remove air convection effects between the diaphragm 404 and the absorbing layer 406.

In one embodiment, the radiation sensor 400 may include thermoelectric patterns on a suspended membrane (e.g. a membrane/diaphragm suspended over a cavity formed in a substrate). Sealed cavities may be formed underneath the membrane during the fabrication process of the radiation sensor 400. The radiation absorber layer may be prepared on a cap layer. The cap layer may be located on top of the thermoelectric patterns. There may be a spacing gap between the cap layer and the thermoelectric patterns. A metal stud may be arranged between the radiation absorber layer and the thermoelectric patterns to effectively convey absorbed heat from the radiation absorber layer to the thermoelectric patterns.

A series of simulations are carried out to model the responsivity (Rs) and detectivity (D*) of a thermopile based IR sensor/detector (e.g. the radiation sensor 200, 300, 400). The temperature difference between the hot-junction and the cold-junction is simulated. The responsivity (Rs) and detectivity (D*) of the sensor is also simulated. To demonstrate the advantages of the design of the sensor, the simulations focus on three major impact: impact of air gap (e.g. spacing gap), impact of vacuum (e.g. cavity) and 3D absorber (e.g. absorbing layer), and impact of metal stud size (e.g. size of supporting element). “3D absorber” may refer to the absorbing layer being arranged on or above the supporting element and the thermopile.

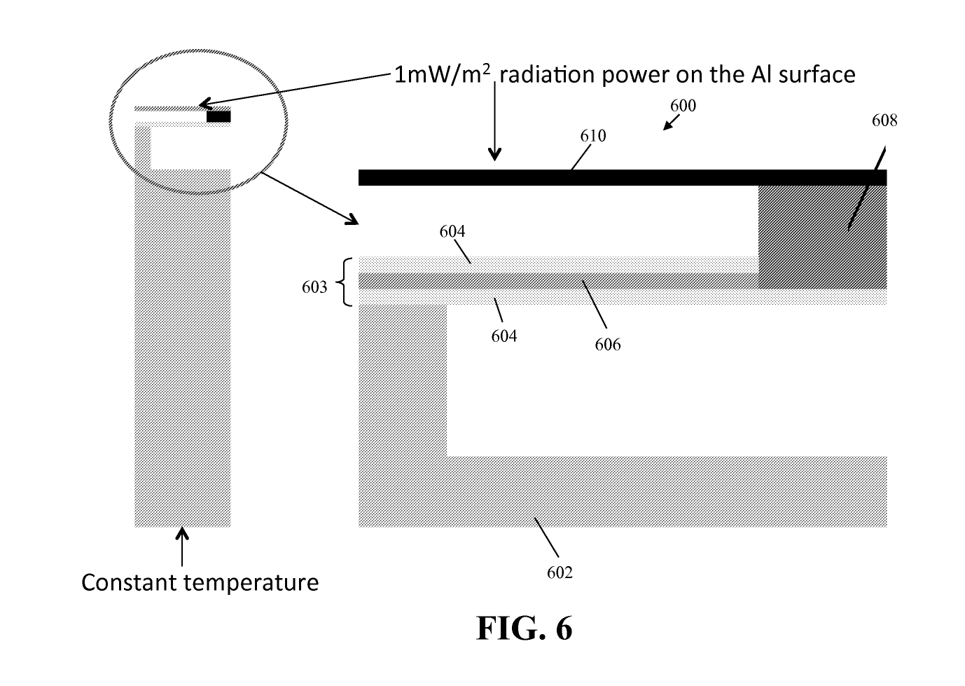

The temperature difference between the hot-junction and the cold-junction has been simulated under the conditions of 1) no 3-D absorber involved, 2) only 3-D absorber involved, and 3) 3-D absorber and vacuum sealing included. FIG. 6 shows an exemplary model of the design of a sensor 600 that includes only 3-D absorber. In one embodiment, the length of the thermopile may vary from about 200 μm to about 600 μm. The width of the thermopile may be fixed at about 16 um. The number of thermocouples in a thermopile is 96. The sensor 600 may include a substrate 602, a thermopile 603 having silicon dioxide portions 604 and a polysilicon portion 606, a contact area (supporting element) 608, and an absorbing layer 610. The substrate 602 may include silicon. The contact area 608 may include copper. The absorbing layer 610 may include aluminum.

The responsivity (Rs) and detectivity (D*) can be calculated using the formulas below.

Vₒᵤₜ=N(α₁−α₂)ΔT=(α₁−α₂)ΔTₜₒₜₐₗ

where Vₒᵤₜ is the voltage generated by the thermopile IR detector, N is the number of thermocouples of the thermopile of the thermopile IR detector, α₁ is the Seebeck coefficient for thermoelectric material A (A is polysilicon), α₂ is the Seebeck coefficient for thermoelectric material B (B is aluminum), ΔT is the temperature difference of each thermocouple, ΔTₜₒₜₐₗ is the sum of the temperature difference of each thermocouple.

The thermopile is a series-connected array of thermocouples. Thus, the voltage generated by the thermopile IR detector is directly proportional to the number of thermocouples N. Two important figures of merit of a thermopile IR detector are sensitivity and specific detectivity.

The sensitivity (Rs) is the ratio of the output voltage per incident radiation power.

$${R}_{s} = \frac{{V}_{out}}{{Φ}_{rad} {A}_{s}}$$

where φ_{rad} is infrared radiation power density and Aₛ is the sensitive area of the detector.

The specific detectivity (D*) is used to compare the performance of different detectors and can be written as

$${D}^{*} = \frac{{R}_{s} \sqrt{{A}_{s}}}{{V}_{noise}}$$

where Vₙₒᵢₛₑ is the noise voltage of the thermopile IR detector.

The noise voltage of the thermopile IR detector can be represented by

Vₙₒᵢₛₑ=\sqrt{4KTR_{elec}Δf}

where K is the Boltzmann constant (1.38×10-23 Joule/Kelvin (J/K)), T is the temperature, R_{elec} is the resistance of the thermopile detector and Δf is the measurement bandwidth.

The R_{elec} of the thermopile detector can be calculated as follows:

$${R}_{elec} = N ( {R}_{□ poly} \frac{{l}_{2}}{{W}_{poly}} + {R}_{□ Al} \frac{{l}_{2}}{{W}_{Al}} + {R}_{contact} )$$

where R_{poly} is the sheet resistance of the polysilicon thermocouple leg, and R_{Al} is the sheet resistance of the aluminum thermocouple leg, W_{poly} is the polysilicon width, W_{Al} is the aluminum width, l₂ is the length of the thermocouple, N is the number of thermocouples of the thermopile of the thermopile IR detector, and R_{contact} is the contact resistance of a thermocouple leg.

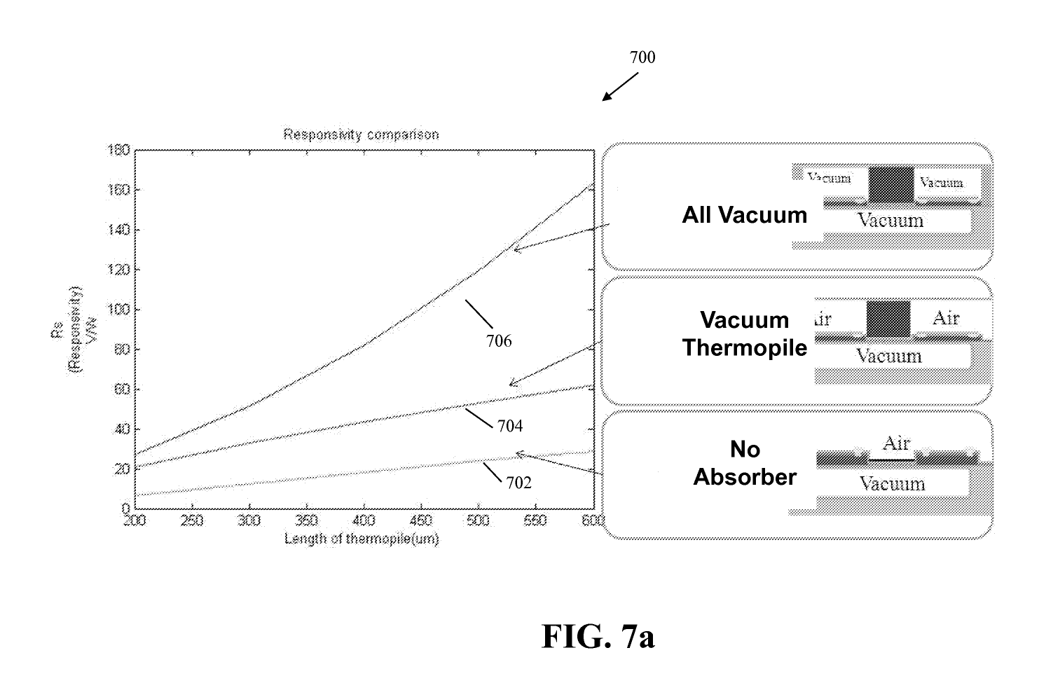

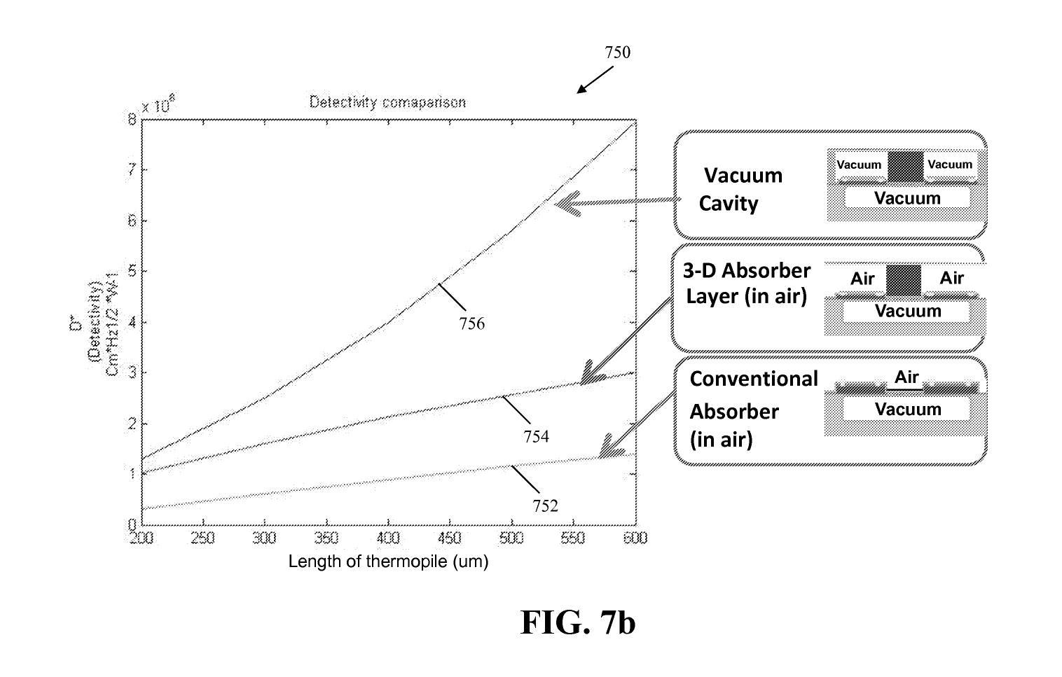

FIG. 7a shows a graph 700 of the simulated results of the sensitivity (Rs) of three designs of the thermopile IR detector/sensor: 1) no 3-D absorber involved, 2) only 3-D absorber involved, and 3) 3-D absorber and vacuum sealing included. Graph 700 shows a plot 702 of sensitivity (Rs) plotted against length of the detector having no 3-D absorber. Graph 700 shows a plot 704 of sensitivity (Rs) plotted against length of the detector having only 3-D absorber. Graph 700 shows a plot 706 of sensitivity (Rs) plotted against length of the detector having 3-D absorber and vacuum sealing. It can be observed that the detector having 3-D absorber and vacuum sealing has better sensitivity (Rs) compared to the detector having no 3-D absorber and the detector having only 3-D absorber.

FIG. 7b shows a graph 750 of the simulated results of the detectivity (D*) of three designs of the thermopile IR detector: 1) no 3-D absorber involved, 2) only 3-D absorber involved, and 3) 3-D absorber and vacuum sealing included. Graph 750 shows a plot 752 of detectivity (D*) plotted against length of the detector having no 3-D absorber. Graph 750 shows a plot 754 of detectivity (D*) plotted against length of the detector having only 3-D absorber. Graph 750 shows a plot 756 of detectivity (D*) plotted against length of the detector having 3-D absorber and vacuum sealing. It can be observed that the detector having 3-D absorber and vacuum sealing has better detectivity (D*) compared to the detector having no 3-D absorber and the detector having only 3-D absorber.

The 3-D absorber and vacuum sealing can enhance the performance of the detector. The 3-D structure can enhance the absorption area and the performance, and the vacuum sealing can provide an opportunity for highly effective thermal utilization.

An optimized design of parameters of the detector can be provided. In the later steps of simulation, the parameters can be fixed as follows: Length of the thermopile is about 600 μm, width of the thermopile is about 16 μm, and the number of thermocouples is 96. The edge length of a supporting element (e.g. metal stud) and a spacing gap of the detector vary in the later steps of simulation.

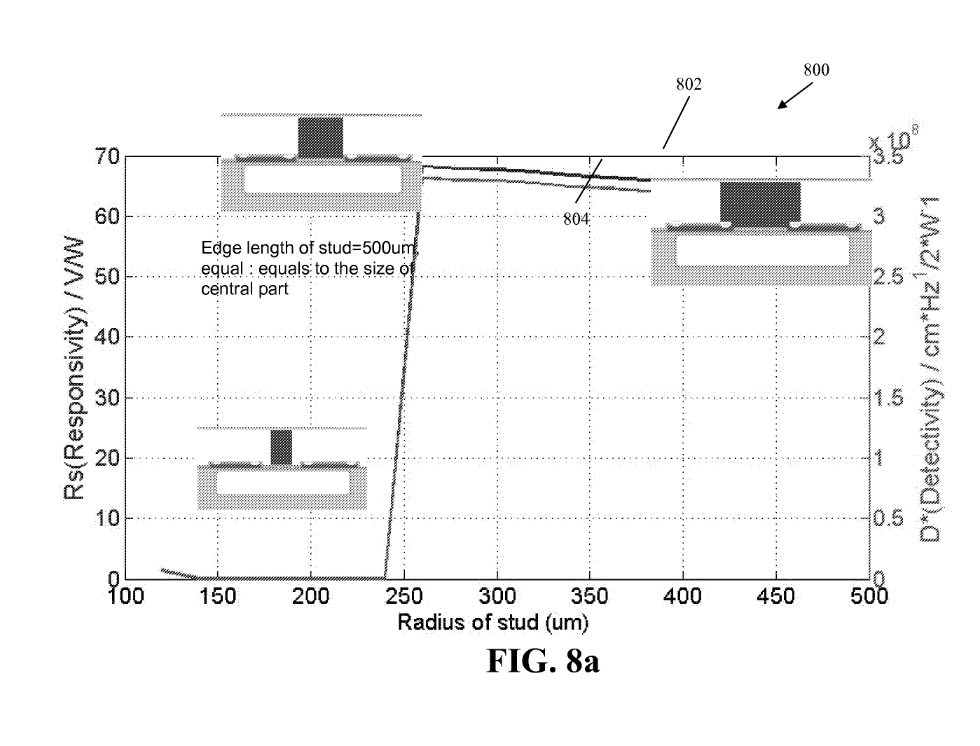

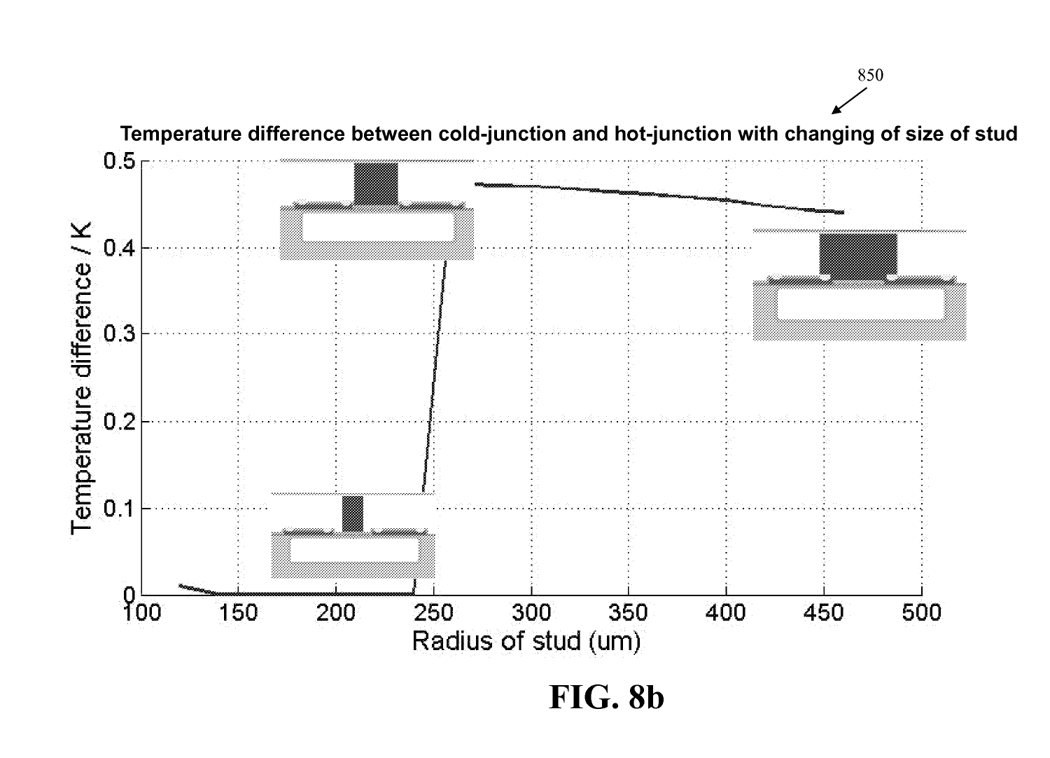

The size of the supporting element can determine how much heat will convert to the thermoelectric parts (e.g. the thermopile). FIGS. 8a and 8b show the impact of the size of the supporting element.

FIG. 8a shows a graph 800 of sensitivity (Rs) and detectivity (D*) plotted against a radius of a supporting element of a detector/sensor. Graph 800 shows a plot 802 of sensitivity (Rs) plotted against the radius of the supporting element of the detector. Graph 800 shows a plot 804 of detectivity (D*) plotted against the radius of the supporting element of the detector.

Under the condition that the size of the supporting element is quite small, the edge of the supporting element is far from the hot-junction. As a result, the heat which is converted to the thermoelectric part is insignificant. When the size of the supporting element increases to 500 μm-by-500 μm (which is equal to the central part of the thermopile), the radius (which means the half length of the edge) of the supporting element increases to 250 μm, which is a milestone. A large amount of heat is converted to the hot-junction of the thermopile of the detector. Therefore, graph 800 shows a jump in the sensitivity (Rs) and the detectivity (D*) of the detector when the radius of the supporting element is around 250 μm.

However, the heating point becomes closer to the cold junction when the size of the supporting element increases further from 250 μm, which leads to a temperature lifting at the cold-junction. Thus, the temperature difference between the hot-junction and the cold-junction decreases as the size of the supporting element increases further from 250 μm, as shown in graph 850 of FIG. 8b. This explains the subsiding of the sensitivity (Rs) and the detectivity (D*) while the size of the supporting element increases.

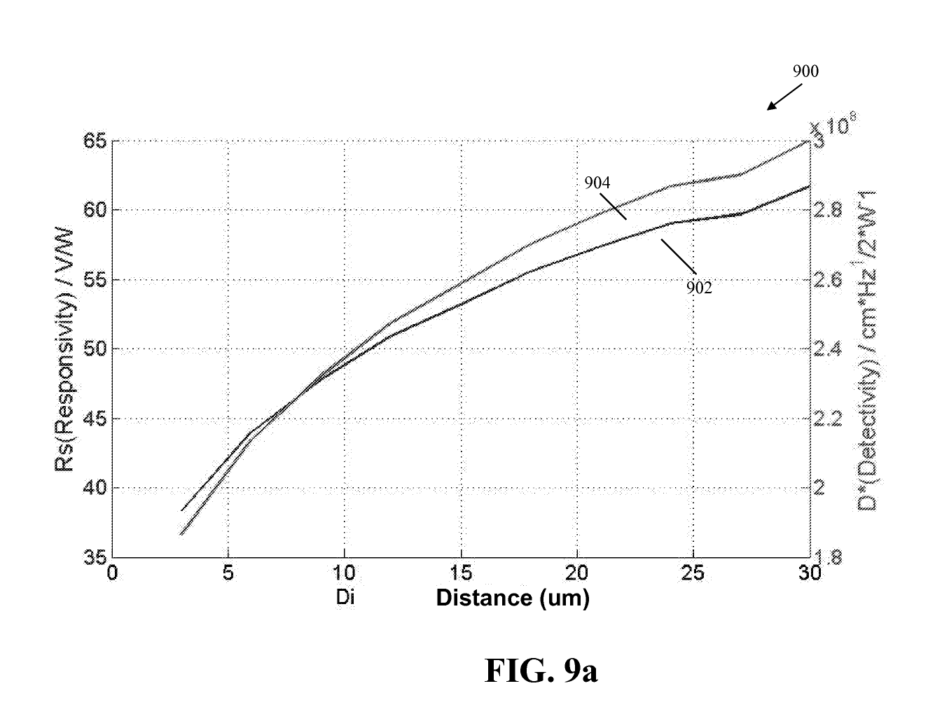

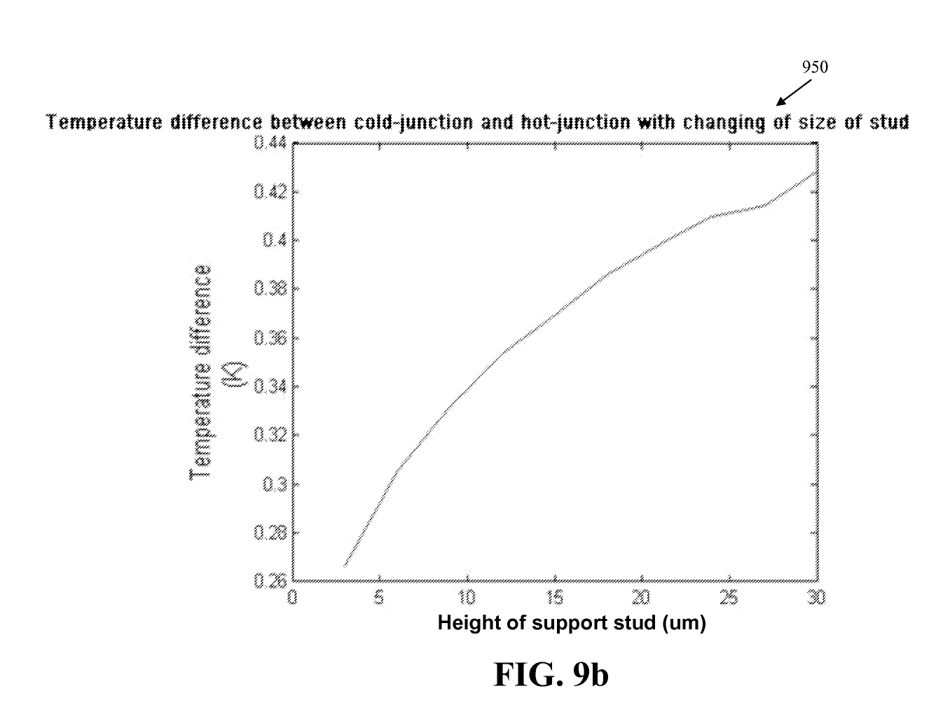

FIGS. 9a and 9b show the simulation results of the impact of air gap (e.g. spacing gap). FIG. 9a shows a graph 900 of sensitivity (Rs) and detectivity (D*) plotted against the spacing gap (i.e. the height of the supporting element). Graph 900 shows a plot 902 of sensitivity (Rs) plotted against the spacing gap. Graph 900 shows a plot 904 of detectivity (D*) plotted against the spacing gap. The sensitivity (Rs) and the detectivity (D*) of the detector increase as the spacing gap increases (i.e. the height of the supporting element increases).

FIG. 9b shows a graph 950 of a temperature difference between the hot-junction and the cold-junction plotted against the spacing gap (i.e. the height of the supporting element). The temperature difference between the hot-junction and the cold-junction increases as the spacing gap increases (i.e. the height of the supporting element increases).

Air convection will bring a lot of heat to the thermopile to heat up the cold-junction. Thus, there is a decrease in rate of increase of temperature difference between the hot-junction and the cold-junction as the spacing gap increases. The sensitivity (Rs) and the detectivity (D*) of the detector increase as the spacing gap increases. The performance of the detector increases while the height of the supporting element becomes larger. However, the larger the air gap is, the larger the metal stud is, which means an increase of surface at the same time. A larger surface leads to more heat loss in the air, and thus the plot 902 and plot 904 in graph 900 and graph 950 become static, e.g. have a zero gradient as the spacing gap/the height of the supporting element increases further from 30 μm.

The conventional thermopile without 3D absorber suffers from that the absorption area is limited to the central part of thermopile which leads to limitation on performance. The conventional micro-bolometer with 3D absorber also has its limitations. The conventional micro-bolometer is so small that the output is limited so as to some applications. The gap between the thermoelectric part and the absorber is so small that the air convection affects the performance seriously.

The simulation results described above suggest that the sensor having 3-D absorber and large gap between the radiation absorber layer and thermoelectric patterns can improve sensor responsivity/sensitivity (Rs) and detectivity (D*), which can thus provide an accurate way for infrared radiation detection.

From the simulation results, the sensor structures of the sensor 200, 300, 400 have several advantages over the conventional IR sensing devices. The 3-D thermoelectric based radiation sensing structure (e.g. sensor 200, 300, 400) has a smaller footprint and a maximized heat absorber area. The IR sensor detect area is not limited to the central part of the thermopile. A large metal stud is used to be an ideal heat path between the radiation absorber layer and the hot junction of thermoelectric beams effectively. The large metal stud can convey the absorbed radiation heat to the hot junction of thermoelectric beams/strips effectively. The large metal stud is formed underneath the absorbing layer so that the whole surface of the absorbing layer can effectively absorb radiation. A larger absorption area (fill factor) can help to increase the IR energy absorption.

The sensor 200, 300, 400 has an enlarged top air gap (i.e. larger than ¼λ) which can effectively reduce the heat loss due to the air convection mechanism when the sensor 200, 300, 400 operated in air. The air gap is independent of wavelength of e.g. infrared light. A large air gap can minimize air convection effect between the top radiation absorber layer and the bottom thermoelectric beams (e.g. between the absorbing layer and the diaphragm). Further enhancement in the performance of the sensor 200, 300, 400 can be achieved using encapsulated vacuum cavities. The encapsulated vacuum cavities can remove any possible air convection.

Post-CMOS (Complementary Metal-Oxide Semiconductor) compatible process can be used to form the underneath vacuum cavity and top-encapsulated vacuum cavity, which can further improve the sensor performance. A total CMOS compatible IR thermopile fabrication process can be used to form the sensor 200, 300, 400. The top-encapsulated vacuum cavity (e.g. first cavity) can be vacuum sealed using e.g. silicon dioxide. A low cost wafer level vacuum encapsulation can be used to reduce heat loss and to enhance the sensitivity of the sensor 200, 300, 400. A thick silicon dioxide sacrificial layer can be used for formation of the supporting element (e.g. metal stud). Front side etching may be used to release the structure of the sensor 200, 300, 400.

The sensor 200, 300, 400 can be used in various applications including a gas sensor, a fluid composition sensor, a pollution sensor and a sensor for hydro-carbon detection.

While embodiments of the invention have been particularly shown and described with reference to specific embodiments, it should be understood by those skilled in the art that various changes in form and detail may be made therein without departing from the spirit and scope of the invention as defined by the appended claims. The elements of the various embodiments may be incorporated into each of the other species to obtain the benefits of those elements in combination with such other species, and the various beneficial features may be employed in embodiments alone or in combination with each other. The scope of the invention is thus indicated by the appended claims and all changes which come within the meaning and range of equivalency of the claims are therefore intended to be embraced.

What is claimed is:

1. A radiation sensor, comprising:
a substrate;
a diaphragm positioned over the substrate;
an absorbing layer which is configured to absorb infrared radiation;
a supporting element arranged between the absorbing layer and the diaphragm such that a spacing gap is formed between the absorbing layer and the diaphragm;
wherein the size of the spacing gap is in a range of about 3.6 micrometer to about 100 micrometer.

2. The radiation sensor according to claim 1, wherein the diaphragm comprises a thermopile structure.

3. The radiation sensor according to claim 2, wherein the thermopile structure has a hot junction and a cold junction, the supporting element being in contact with the hot junction of the thermopile structure.

4. The radiation sensor according to claim 1, wherein the size of the spacing gap is in a range of about 5 micrometer to about 100 micrometer.

5. The radiation sensor according to claim 1, wherein the diaphragm has a thermal connection to the absorbing layer through the supporting element.

6. The radiation sensor according to claim 1, wherein the supporting element is made of conductive material.

7. The radiation sensor according to claim 6, wherein the supporting element is solid or not solid.

8. The radiation sensor according to claim 2, wherein a first cavity is formed between the absorbing layer and the substrate, the first cavity encapsulating the thermopile structure and the supporting element.

9. The radiation sensor according to claim 8, wherein the first cavity is vacuum.

10. The radiation sensor according to claim 1, further comprising a second cavity formed in the substrate, wherein the diaphragm is suspended across the second cavity.

11. The radiation sensor according to claim 10, wherein the second cavity is vacuum.

12. The radiation sensor according to claim 1, wherein the absorbing layer covers the diaphragm in an umbrella type configuration.

13. A radiation sensor comprising:
a substrate;
a diaphragm positioned over the substrate;
an absorbing layer which is configured to absorb infrared radiation;
a supporting element arranged between the absorbing layer and the diaphragm such that the absorbing layer has a spaced apart relationship with respect to the diaphragm;
a first cavity formed between the absorbing layer and the substrate, the first cavity being vacuum.

14. The radiation sensor according to claim 13, further comprising a second cavity formed in the substrate, wherein the diaphragm is suspended across the second cavity.

15. The radiation sensor according to claim 14, wherein the second cavity is vacuum.

16. The radiation sensor according to claim 13, wherein the diaphragm comprises a thermopile structure.

17. The radiation sensor according to claim 16, wherein the thermopile structure has a hot junction and a cold junction, the supporting element being in contact with the hot junction of the thermopile structure.

18. The radiation sensor according to claim 13, wherein the diaphragm has a thermal connection to the absorbing layer through the supporting element.

19. The radiation sensor according to claim 13, wherein the supporting element is made of conductive material.

20. The radiation sensor according to claim 19, wherein the supporting element is solid or not solid.
